(19) United States
(12) Patent Application Publication
(10) Pub. No.: US 2021/0385313 A1
(43) Pub. Date: Dec. 9, 2021

(54) DEFECT-FREE DESIGN SOLUTION FOR AB DOUBLE-SIDED AND DOUBLE-SCREEN SMART PHONE

(71) Applicants: yong liu, Harbin (CN); guixian liu, Harbin (CN)

(72) Inventors: yong liu, Harbin (CN); guixian liu, Harbin (CN)

(21) Appl. No.: 17/285,839

(22) PCT Filed: Dec. 27, 2018
(86) PCT No.: PCT/CN2018/124531

§ 371 Date: Apr. 15, 2021

(30) Foreign Application Priority Data
Oct. 19, 2018 (CN) 201811223121.7

(51) Int. Cl. H04M 1/02; G06F 1/16; G06F 3/041

(52) U.S. Cl. CPC H04M 1/0266; H04M 1/0264; H04M 2201/38; G06F 3/0412; G06F 1/165

(57) ABSTRACT

Several key points about the design scheme in the specification: 1. The smartphone is designed with AB double-sided double screen. 2. The unrestricted arrangement of the large touch display screen (the screen-to-body ratio is less than or equal to 100%) of smartphone (Side A). 3. On the side of the small touch display screen that gathers the handset opening(Earpiece opening), main camera lens and selfie camera lens (Side B), the main camera and selfie camera can be mutually independent or combined. The total number of camera lenses can be 1−n. 4. In order not to marginalize the phone function of smartphone, the phone function is arranged on the side of the small touch display screen (Side B). The handset opening(Earpiece opening) is still in an important position. 5. Avoid adding internal or external mechanical parts. 6. All the components and their windows or openings on the side of the small touch display screen, including the touch screen, can be designed and arranged flexibly in terms of specifications and location.

### TECHNICAL FIELD

Communication and smartphone.

### BACKGROUND ART

Smartphone is increasingly becoming an indispensable smart space and carrier for individuals who gather all kinds of living and production tools to establish communication and cooperation with the world.

### SUMMARY OF INVENTION

### Technical Problem

With the manufacturers' and consumers' extreme pursuit of functionality, practicality and performance of smartphones, new designs of mobile phones emerge endlessly, especially new designs for full screens with a high screen-to-body ratio. However, it seems that a solution that does not marginalize basic functions, especially basic phone functions, has never been found.

### SOLUTION TO PROBLEM

### Technical Solution

The smartphone of this design is designed with AB double-sided double screen, the side of a large touch screen is Side A, and the side of a small touch screen is Side B. Place a large touch display screen with a screen-to-body ratio of less than or equal to 100% on the Side A of the smartphone. Arrange a small touch display screen with an appropriate size, Earpiece opening(handset and its opening), the lens of the main camera and selfie camera in a suitable position on Side B. The main camera and selfie camera can be mutually independent or combined. Therefore, the total number of camera lenses can be 1−n. Based on the above, the side of a small touch screen (Side B) can be arranged with other components such as sensors and their windows or openings that need to occupy the space of an independent panel, as well as under-screen sensors and other components. Side A can be fully or partially used for the arrangement of a large touch display screen with a screen-to-body ratio of less than or equal to 100%. Another description of this design: Side B of AB double-sided double-screen smartphone is equivalent to the front of a traditional smartphone where the main camera lens on the back of a traditional smartphone is flipped and moved. The moved main camera lens is on the same side as the Earpiece opening, small touch display screen and selfie camera lens (the main camera and selfie camera can be mutually independent or combined, Therefore, the total number of camera lenses can be 1−n), clearing the back of such traditional smartphone to form Side A to place a touch display screen with a screen-to-body ratio of less than or equal to 100% on Side A. With the large screen of Side A, the components on Side B that occupy and do not occupy the panel space, such as the touch display screen, camera lens and Earpiece opening(handset and its opening), can be designed and arranged flexibly in terms of location and specifications

### Beneficial Effect of the Invention

The following effects can be basically achieved in this design: 1. The handset and its opening(Earpiece opening) are still in an important position and not marginalized; 2. Design of size and shape of the large touch display screen will not be disturbed and restricted; 3. There is no need to add internal or external mechanical parts; 4. The new and old functions of mobile phones are not marginalized, with sufficient space.

### BRIEF DESCRIPTION OF THE DRAWINGS

### Description of the Drawings

Description of the drawings: FIG. 1 of drawings is the visual illustration diagram of the core concept of this design, mainly to illustrate that the handset and its opening(Earpiece opening), the main camera and the selfie camera (they can be mutually independent or combined, Therefore, the total number of camera lenses can be 1−n) lens, as well as the small touch display screen with appropriate size, specification, shape and location are arranged on a plane (Side B) at the same time, and other components occupying the panel space and their openings and windows also have sufficient arrangement space on this plane (side B). The A side of the mobile phone can be fully or partially used for the arrangement of a large touch display screen with a screen-to-body ratio of less than or equal to 100%. FIG. 1 is not the design drawing of a specific structure and appearance.

### Best Implementation Method of this Invention

[symbol]

### EMBODIMENTS OF INVENTION

### Implementation Method of this Invention

[symbol]

### Industrial Applicability

[symbol]

### Free Content of Sequence Listing

[symbol]

1. The smartphone is designed with AB double-sided double screen, in which a large touch screen with a screen-to-body ratio of less than or equal to 100% is placed on the Side A of the mobile phone as the large screen display and operation area, It is possible but not necessary to arrange other components such as sensors and their windows or openings that occupy panel space except for the large touch display screen and under-screen sensors on Side A, Side A can be fully or partially used for the arrangement of a large touch display screen, The small touch display screen with an appropriate size, handset opening(Earpiece opening), one or several lenses of main camera and selfie camera (the main camera and selfie camera can be mutually independent or combined, therefore, the total number of camera lenses can be 1−n) can be flexibly arranged in various positions on the Side B of mobile phone as the display and operation area mainly for making and receiving calls, On this basis, Side B can be arranged with other components such as sensors and their windows or openings that need to occupy panel space, as well as under-screen sensors and other components.

2. Side B of AB double-sided double-screen smartphone in this design is equivalent to the front of a traditional smartphone where the main camera lens on the back of a traditional smartphone with the standard screen is flipped and moved, The moved main camera lens is on the same side as the handset opening(Earpiece opening), touch display screen and selfie camera lens (the main camera and selfie camera can be mutually independent or combined, Therefore, the total number of camera lenses can be 1−n), clearing the back of phone completely to form Side A to place a touch display screen with a screen-to-body ratio of less than or equal to 100% on Side A, With the large touch screen of Side A, the touch display screen, handset opening(Earpiece opening) and camera lens on Side B can be designed and arranged flexibly in terms of specifications and location.
